(19) United States
(12) Patent Application Publication
(10) Pub. No.: US 2015/0355593 A1
(43) Pub. Date: Dec. 10, 2015

(54) TRANSFORMER, POWER SUPPLY, AND IMAGE FORMING APPARATUS

(71) Applicant: CANON KABUSHIKI KAISHA, Tokyo (JP)

(72) Inventor: Nobuyuki Uchiyama, Mishima-shi (JP)

(21) Appl. No.: 14/730,736

(22) Filed: Jun. 4, 2015

(30) Foreign Application Priority Data
Jun. 10, 2014 (JP) 2014-120004

(51) Int. Cl. G03G 15/00; H01F 27/32; H01F 27/28; H02M 3/335; H01F 27/24

(52) U.S. Cl. CPC G03G 15/80; H02M 3/33546; H01F 27/24; H01F 27/2823; H01F 27/325

(57) ABSTRACT

A transformer includes a core, a primary winding, a first secondary winding and a second secondary winding, a bobbin around which the primary winding, the first secondary winding, and the second secondary winding are wound, wherein the primary winding is disposed between the first secondary winding and the second secondary winding.

### BACKGROUND OF THE INVENTION

1. Field of the Invention

The present invention relates to a configuration of a transformer used in a current resonance power supply.

2. Description of the Related Art

A current resonance type power supply is known as a switching power supply that provides a relatively high power conversion efficiency with low noise. In the current resonance type power supply, particular leakage inductance is necessary in a circuit operation. Two structures described below are known to construct an electromagnetic transformer (herein also referred to simply as a transformer). One type is a divided-winding transformer in which winding regions are completely separated between a primary winding and a secondary winding of the transformer. The other type is a general-purpose multilayer transformer (see, for example, Japanese Patent Laid-Open No. 2009-38244). These two types of structures are properly selected depending on the size, the application, and the like.

For example, a structure in which a center tap transformer is constructed in the form of the multilayer transformer may be advantageously employed to reduce the size of the transformer for use in current resonance power supply. However, in the multilayer type, there is a possibility that an imbalance occurs between positive and negative currents flowing through the primary winding of the transformer. To achieve desired positive and negative currents assuming an imbalance between positive and negative currents, it is necessary to employ a switching device with a large switching capacity to drive the transformer. The switching device with the large switching capacity is expensive, which causes an increase in cost of the power supply. Thus, in the electromagnetic transformer for use in the current resonance power supply, there is a need for achieving both a reduction in size and a reduction in cost.

### SUMMARY OF THE INVENTION

The present invention provides a transformer with a small size capable of providing a small difference between positive and negative currents.

In an aspect of the invention, a transformer includes a core, a primary winding, a first secondary winding and a second secondary winding, and a bobbin around which the primary winding, the first secondary winding, and the second secondary winding are wound, wherein the primary winding is disposed between the first secondary winding and the second secondary winding.

Further features of the present invention will become apparent from the following description of exemplary embodiments with reference to the attached drawings.

### BRIEF DESCRIPTION OF THE DRAWINGS

FIG. 1 is a circuit diagram of a current resonance power supply according to a first embodiment.

FIGS. 2A to 2C are diagrams conceptually illustrating a manner in which current flows through a transformer according to second embodiment.

FIGS. 3A to 3C are diagrams illustrating waveforms of currents flowing through a switching element (FET) and a transformer according to a third embodiment.

FIG. 4 is a cross-sectional view of a transformer according to the first embodiment.

FIG. 5 is a cross-sectional view of a transformer according to the second embodiment.

FIG. 6 is a cross-sectional view of a transformer according to the third embodiment.

FIG. 7 is a diagram illustrating an image forming apparatus using a current resonance power supply.

### DESCRIPTION OF THE EMBODIMENTS

### First Embodiment

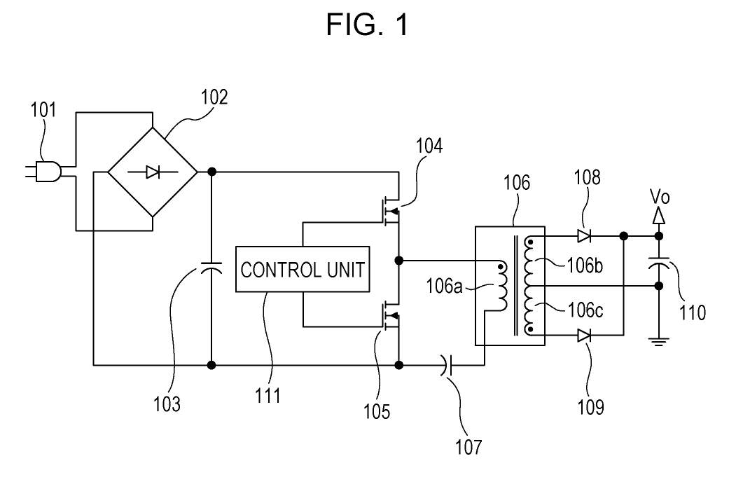

A first embodiment of the invention is described below with reference to FIGS. 1 to 4. FIG. 1 is a circuit diagram of a current resonance power supply. In FIG. 1, reference numeral 101 denotes an AC plug that is to be connected to an outlet to supply an alternating current (AC) voltage from a commercial AC power source to the current resonance power supply. The supplied AC voltage is full-wave rectified by a diode bridge circuit 102 via a non-illustrated line filter and then smoothed by a smoothing capacitor 103, and a resultant direct-current voltage (DC voltage) is output. This DC voltage alternately drives two FETs, that is, a FET 104 and FET 105, functioning as switching elements such that each FET is driven with a duty ratio of 50%. As a result, a current is passed through a primary winding 106a of a transformer 106 and an electric charge is stored in a resonance capacitor 107 (that is, the resonance capacitor 107 is charged). Note that the FET 104 and the FET 105 are driven under the control of a control unit (control IC) 111. The FET 104 is connected to a high potential side, and thus the FET 104 is also referred to as a high-side FET. On the other hand, the FET 105 is connected to a low-potential side, and thus the FET 105 is also referred to as a low-side FET. When the high-side FET 104 is driven, a current flows through a secondary winding 106b of the transformer 106 and electric power is supplied to a load on a secondary side via a diode 108. On the other hand, when the low-side FET 105 is driven, a current flows through a secondary winding 106c of the transformer 106 and electric power is supplied to the load on the secondary side via a diode 109. Note that reference numeral 110 denotes a smoothing capacitor on the secondary side. Note that the control unit 111 drives (turns on/off) the high-side FET 104 and the low-side FET 105 such that both FETs 104 and 105 are in an off-state for a particular period (hereinafter referred to as a dead time period). The provision of the dead time period in the switching operation allows a reduction in noise generated in the switching operation. The voltage applied to the load on the secondary side is controlled to be constant by controlling the switching frequency of the FET 104 and the FET 105. More specifically, the switching frequency is controlled such that an output voltage of the secondary winding 106 is detected and compared with a target output voltage, and the switching frequency is controlled by the control unit 111 based on a comparison result.

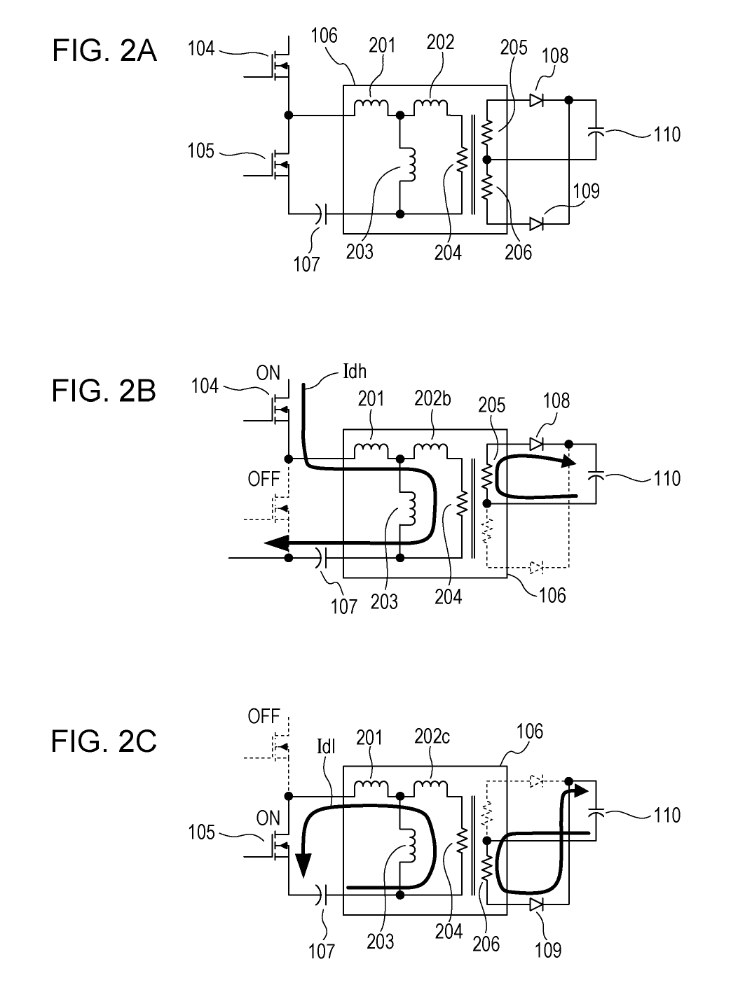

FIGS. 2A to 2C are equivalent circuit diagrams of the transformer 106 used in the current resonance power supply. Note that only part of the circuit elements in FIG. 1 is shown in FIGS. 2A to 2C. In FIG. 2A, reference numeral 106 denotes a transformer, and reference numeral 201 denotes a leakage inductance on a primary side of the transformer 106. In flyback power supplies generally used for supplying small electric power and also in forward power supplies generally used for supplying middle and large electric power, the leakage inductance 201 on the primary side is an element having no contribution to a circuit operation. However, in the current resonance power supply, the leakage inductance 201 on the primary side is intentionally used in a circuit operation, and thus the leakage inductance 201 is an element important for the circuit operation. Reference numeral 202 denotes a leakage inductance that actually exists on the secondary side but is equivalently represented as a leakage inductance existing on the primary side. Reference numeral 203 denotes an exciting inductance. Reference numeral 204 denotes a DC resistance of a primary winding. Reference numeral 205 denotes a DC resistance of a secondary winding for outputting a positive voltage, and reference numeral 206 denotes a DC resistance of a secondary winding for outputting a negative voltage. Note that in the present equivalent circuit, the leakage inductance of each of these secondary windings is equivalently represented on the primary side, and thus no leakage inductance exists on the secondary side. Note that the positive output is an output that is provided when the current is passed through the transformer 106 in a direction from the middle point between the two FETs 104 and 105 to a resonance capacitor 107 via the transformer 106. On the other hand, the negative output is an output that is provided when the current is passed through the transformer 106 in a direction from the resonance capacitor 107 to the middle point between the two FETs 104 and 105 via the transformer 106.

FIG. 2B is a diagram conceptually illustrating a manner in which a current flows through a circuit on the primary side of the transformer and a current flows through a circuit on the secondary side of the transformer when the high-side FET 104 is driven to be turned on. When the high-side FET 104 is turned into an on-state, a current Idh is supplied from the smoothing capacitor 103 serving as a power supply source and passed through the high-side FET 104, the circuit on the primary side of the transformer 106, and the resonance capacitor 107. As a result, a particular amount of electric charge is stored in the resonance capacitor 107. In response, a voltage occurs on the side of the anode of diode 108 and electric power is supplied to the load on the secondary side via the diode 108. In this state, the leakage inductance of the secondary winding 106b equivalently exists as the leakage inductance 202b on the primary side where the equivalent leakage inductance 202b is greater than the leakage inductance of the secondary winding 106b by a factor given by a ratio of the number of turns between the primary winding 106a and secondary winding 106b.

FIG. 2C is a diagram conceptually illustrating a manner in which a current flows through the circuit on the primary side of the transformer and a current flows through the circuit on the secondary side of the transformer when the low-side FET 105 is driven to be turned on. When the low-side FET 105 is turned into the on-state, a current Idl is supplied from the resonance capacitor 107, which has been charged during the state illustrated in FIG. 2B and which serves as a power supply source in the present state shown in FIG. 2C, and the current Idl flows through the circuit on the primary side of the transformer 106 in a direction opposite to that in FIG. 2B. More specifically, the current Idl starts from an electrode of the resonance capacitor 107 on the side of the transformer 106 and passes through the primary-side leakage inductance 201 and the low-side FET 105, and finally returns to the resonance capacitor 107. In response, a voltage occurs on the side of the anode of diode 109 and electric power is supplied to the load on the secondary side via the diode 109. In this state, the leakage inductance of the secondary winding 106c equivalently exists as the leakage inductance 202c on the primary side where the equivalent leakage inductance 202c is greater than the leakage inductance of the secondary winding 106c by a factor given by a ratio of the number of turns between the primary winding 106a and the secondary winding 106c. Note that the equivalent leakage inductance 202c in the state shown in FIG. 2C is not strictly equal to the equivalent leakage inductance 202b in the state shown in FIG. 2B in which the high-side FET 104 is in the on-state.

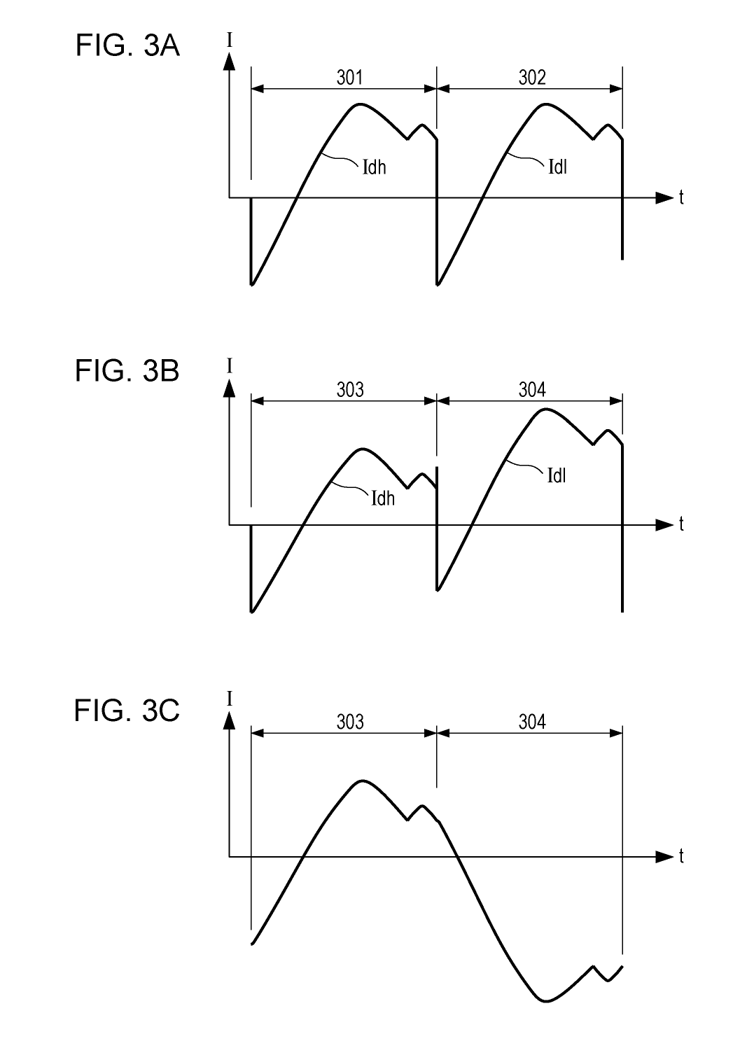

FIGS. 3A to 3C illustrate waveforms of currents flowing through the high-side FET 104 and the low-side FET 105 in a state in which electric power is supplied to a particular load from the current resonance power supply, wherein horizontal axes represent a time (t) and vertical axes represent a current (I). In FIG. 3A, reference numeral 301 denotes a current Idh flowing through the high-side FET 104, and reference numeral 302 denotes a current Idl flowing through the low-side FET 105. In a case where the leakage inductance 202b, described above with reference to FIG. 2, equivalently expressed on the primary side that actually exists on the secondary winding 106b is nearly equal to the leakage inductance 202c equivalently expressed on the primary side that actually exists on the secondary winding 106c, both the current Idh and the current Idl have a similar waveform as illustrated in FIG. 3A. This also means that the coupling factor between the primary winding 106a and the secondary winding 106b is similar to the coupling factor between the primary winding 106a and the secondary winding 106c. However, on the other hand, in a case where the coupling factor between the primary winding 106a and the secondary winding 106b is different from the coupling factor between the primary winding 106a and the secondary winding 106c, there is a difference between the leakage inductance 202b and leakage inductance 202c, which are equivalently expressed on the primary side for leakage inductance on the secondary side. That is, in this case, a difference occurs in waveform between the high-side FET 104 and the low-side FET 105 as illustrated in FIG. 3B.

In FIG. 3B, reference numeral 303 denotes a current Idh flowing through the high-side FET 104, and reference numeral 304 denotes a current Idl flowing through the low-side FET 105. This indicates an example in which the coupling factor of the leakage inductance 202b is greater than the coupling factor of the leakage inductance 202c. FIG. 3C illustrates a waveform of the current flowing through the transformer 106 corresponding to the waveform of the FET current illustrated in FIG. 3B. Note that the current Idl (304) in FIG. 3C and the current Idl in FIG. 3B are symmetric about the horizontal axis. When there is such large a difference between the leakage inductance 202b and the leakage inductance 202c of the secondary windings, a difference occurs in the peak value between the positive current Idh and the negative current Idl flowing through transformer 106. That is, degradation occurs in the balance between the positive and negative currents. In this case, the transformer 106 needs a DC superposing characteristic adapted to the greater peak of the current, which may result in an increase in size of the transformer 106.

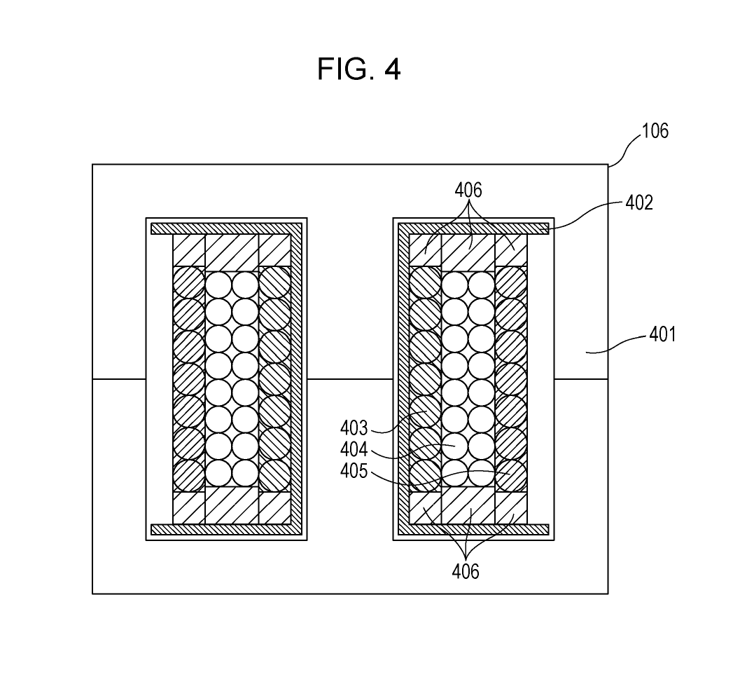

FIG. 4 illustrates a cross-sectional view of the transformer 106 that is of the center tap type constructed in the form of the multilayer winding structure for use in the current resonance power supply. In FIG. 4, reference numeral 401 denotes a magnetic material functioning as a core, and reference numeral 402 denotes a bobbin for providing a winding region for windings. In this structure of the transformer, two cores 401 having the same shape are inserted from upper and lower sides into the bobbin 402, and windings are wound in a line-symmetric manner around a part, in the center in the horizontal direction, of the core 401. Reference numeral 403 denotes the secondary winding 106b on the positive output side, reference numeral 404 denotes the primary winding 106a, and reference numeral 405 denotes the secondary winding 106c on the negative output side. Reference numeral 406 denotes a barrier tape that ensures a creepage distance for the secondary winding 403 or the secondary winding 405 with respect to the primary winding 404. In the present embodiment, the primary winding 403 and the secondary winding 405 have the same number of turns.

The present embodiment is characterized in that the primary winding 404 is disposed between the secondary winding 403 and the secondary winding 405. By forming the primary winding 404, the secondary winding 403, and the secondary winding 405 in the above-described manner, it becomes possible for the secondary windings 403 and 405 to have the same contact area with the primary winding 404. That is, it becomes possible to achieve substantially the same value for the coupling factor between the secondary winding 403 and the primary winding 404 and for the coupling factor between the secondary winding 405 and the primary winding 404. This makes it possible to reduce the size of the transformer to an optimum size.

Although in the present embodiment, the secondary winding 403 is formed at an innermost location of the bobbin 402 and the secondary winding 405 is formed at an outermost location, the locations of the secondary windings 403 and 405 may be reversed to achieve similar effects. Although not illustrated, the multilayer transformer 106 includes a tape wound with several turns for insulation disposed in an interlayer between the primary winding 404 and the secondary winding 403 and also a tape sound with a several turns in an interlayer between the primary winding 404 and the secondary winding 405. By forming the tapes in the interlayers such that they have the same number of turns for the interlayer between the primary winding 404 and the secondary winding 403 and for the interlayer between the primary winding 404 and the secondary winding 405, it becomes possible to easily adjust the coupling factors.

Although in the present embodiment, the primary winding and the secondary windings have the same number of turns, the number of turns may be different among the windings. A slight difference in the number of terms among the windings may be allowed to achieve the effects of the present embodiment.

### Second Embodiment

In the first embodiment described above, the primary winding 404 is disposed between the secondary windings 403 and 405 to achieve the substantially equal value for the coupling factor between the primary winding 404 and the secondary winding 403 and for the coupling factor between the primary winding 404 and the secondary winding 405. In contrast, in a second embodiment described below, the primary winding 404 is divided into two parts with an equal number of turns, and the secondary windings 403 and 405 are disposed between the two equal parts of the primary winding 404 to achieve a substantially equal value for the coupling factor between the primary winding 404 and the secondary winding 403 and for the coupling factor between the primary winding 404 and the secondary winding 405.

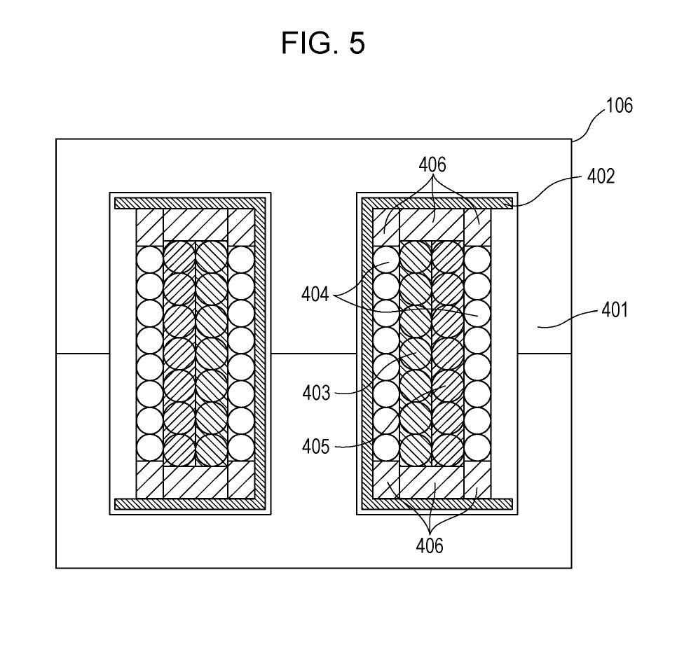

More specifically, in contrast to the structure illustrated in FIG. 4, the secondary windings 403 and 405 are disposed between the two parts of the primary winding 404 as illustrated in FIG. 5. By employing this structure, it is possible to achieve a similar value for the contact area between the secondary winding 403 and the primary winding 404 and the contact area between secondary winding 405 and the primary winding 404. Thus, it is possible to achieve the substantially equal value for the coupling factor between the primary winding 404 and the secondary winding 403 and for the coupling factor between the primary winding 404 and the secondary winding 405.

By employing the above-described structure in which the secondary windings 403 and 405 are disposed between the two equal parts of the primary winding 404, it is possible to achieve the substantially equal value for the coupling factor between the primary winding 404 and the secondary winding 403 and for the coupling factor between the primary winding 404 and the secondary winding 405. Note that in a case where the primary winding 404 has an odd number of turns, the primary winding 404 may not be divided into exactly equal two parts, but the number of turns of either one of the two divided parts may be greater by one than the other one. However, the difference by one turn results in only an extremely small difference between the leakage inductance 202b and the leakage inductance 202c, and thus it is possible to achieve substantially equal coupling factors.

Also in the present embodiment, it is assumed by way of example that the number of turns of the primary winding is equal to the number of turns of each secondary winding, the number of turns may be different among the windings. A slight difference in the number of turns among the windings may be allowed to achieve the effects of the present embodiment.

### Third Embodiment

In the first and second embodiments described above, the winding regions of the secondary windings 403 and 405 are separated in the horizontal direction, and the primary winding 404 is disposed between the secondary windings 403 and 405, or the primary winding 404 is divided into two equal parts and the secondary windings 403 and 405 are disposed between the two equally divided parts. By employing either one of the structures described above, it is possible to achieve the substantially equal value for the coupling factor between the primary winding 404 and the secondary winding 403 and for the coupling factor between the primary winding 404 and the secondary winding 405.

In contrast, in a third embodiment described below, the secondary windings 403 and 405 are wound in a single same layer as seen in a horizontal direction, and this layer is disposed between two equally divided parts of the primary winding 404 thereby achieving the substantially equal value for the coupling factor between the primary winding 404 and the secondary winding 403 and for the coupling factor between the primary winding 404 and the secondary winding 405.

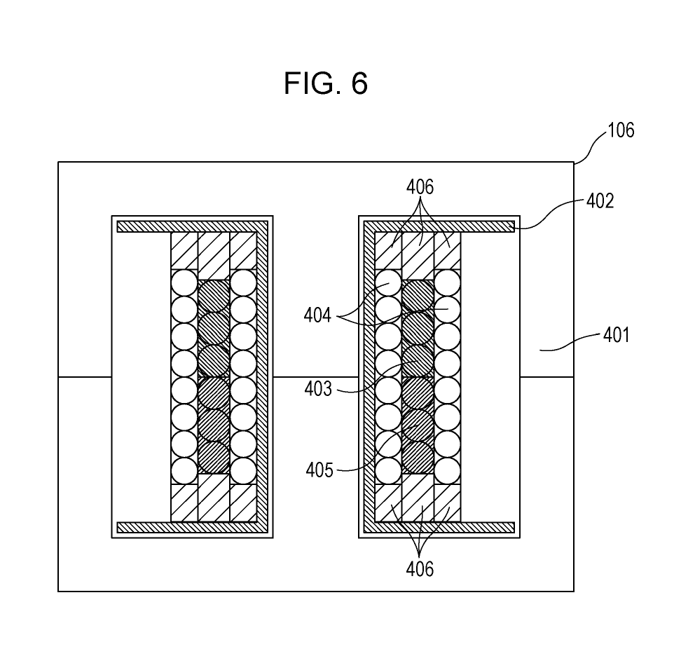

FIG. 6 illustrates an example of a structure according to the third embodiment of the invention. More specifically, FIG. 6 illustrates a cross-sectional view of the inner structure of the multilayer transformer 106 according to the present embodiment. In FIG. 6, similar elements of parts to those in FIG. 4 or FIG. 5 are denoted by similar reference numerals. By constructing the transformer 106 in this manner, it is possible for the secondary windings 403 and 405 to have the same contact area with the primary winding 404. Thus, it is possible to achieve the substantially equal value for the coupling factor between the primary winding 404 and the secondary winding 403 and for the coupling factor between the primary winding 404 and the secondary winding 405.

As described above, in the present embodiment, the secondary windings 403 and 405 are wound in the same layer extending in the vertical direction in the figures, and this layer is disposed between two equally divided parts of the primary winding 404 thereby achieving the substantially equal value for the coupling factor between the primary winding 404 and the secondary winding 403 and for the coupling factor between the primary winding 404 and the secondary winding 405.

Note that similar effects are obtained in a structure in which the locations of the secondary winding 403 and the secondary winding 405 are vertically (as seen in FIG. 6) replaced by each other. Note that in the first to third embodiments, similar effects may be obtained in both the vertical transformer and the horizontal transformer. In a case where the transformer includes a plurality of systems that provide a plurality of output voltages (in a multiple-output configuration), similar effects to those described above may be achieved by employing one of the structures of the secondary wirings in terms of the coupling factor for each system.

Also in the present embodiment, it is assumed by way of example that the number of turns of the primary winding is equal to the number of turns of each secondary winding, the number of turns may be different among the windings. A slight difference in the number of turns among the windings may be allowed to achieve the effects of the present embodiment.

### Fourth Embodiment

The current resonance power supply including the transformer according to one of the embodiments described above may be used, for example, as a low voltage power supply for use in an image forming apparatus to supply electric power to a controller (CPU), a driving unit such as a motor, and the like. An example of a structure of an image forming apparatus using the power supply according to one of the embodiments is described below.

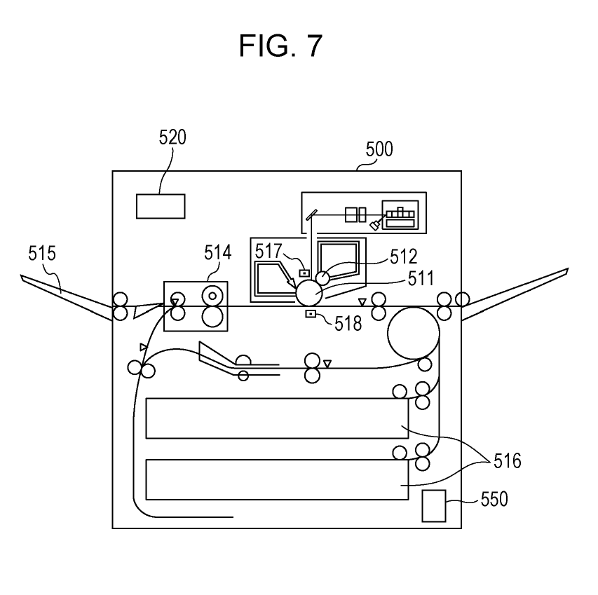

Herein, a laser beam printer is taken as an example of an image forming apparatus. FIG. 7 schematically illustrates an example of a structure of the laser beam printer, which is an example of an electrophotographic printer. The laser beam printer 500 includes a photosensitive drum 511 serving as an image bearing member on which an electrostatic latent image is formed, a charger 517 (charging unit) that uniformly charges the photosensitive drum 511, and a developing unit 512 that develops, using toner, the electrostatic latent image formed on the photosensitive drum 511. A transfer unit 518 transfers a toner image developed on the photosensitive drum 511 onto a sheet (not illustrated) serving as a recording material fed from a cassette 516, and the toner image transferred to the sheet is fixed by a fixing unit 514. The sheet is then discharged onto a tray 515. The photosensitive drum 511, the charger 517, the developing unit 512, and the transfer unit 518 form an image forming unit. The laser beam printer 500 includes a power supply apparatus 550 realized according to one of the embodiments described above. Note that the structure of the image forming apparatus including the power supply apparatus 550 realized according to one of the embodiments described above is not limited to the structure illustrated in FIG. 7, but, the image forming apparatus may be constructed in a different structure. For example, the image forming apparatus may include a plurality of image forming units. Alternatively, the image forming apparatus may further include a first transfer unit that transfers a toner image from the photosensitive drum 511 to an intermediate transfer belt, and a second transfer unit that transfers the toner image from the intermediate transfer belt to a sheet.

The laser beam printer 500 also includes a controller 520 that controls an image forming operation performed by the image forming unit, a sheet conveying operation, and the like. The power supply apparatus 550 according to one of the embodiments described above supplies electric power, for example, to the controller 520. The power supply apparatus 550 also supplies electric power to a driving unit such as a motor or the like that rotates the photosensitive drum 511 or drives a roller or the like to convey the sheet.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-120004, filed Jun. 10, 2014, which is hereby incorporated by reference herein in its entirety.

What is claimed is:

1. A transformer comprising:
a core;
a primary winding;
a first secondary winding and a second secondary winding; and
a bobbin around which the primary winding, the first secondary winding, and the second secondary winding are wound,
wherein the primary winding is disposed between the first secondary winding and the second secondary winding.

2. The transformer according to claim 1, wherein the number of turns of the first secondary winding is substantially equal to the number of turns of the second secondary winding.

3. The transformer according to claim 1, wherein
the transformer is a multilayer type transformer,
the first secondary winding is wound around the bobbin,
the primary winding is wound around the first secondary winding via a barrier tape, and
the second secondary winding is wound around the primary winding via a barrier tape.

4. A power supply comprising:
a transformer including a core, a primary winding, a first secondary winding and a second secondary winding, and a bobbin around which the primary winding, the first secondary winding, and the second secondary winding are wound, wherein the primary winding is disposed between the first secondary winding and the second secondary winding; and
a switching element connected to the primary winding,
wherein the switching element is driven to induce a voltage on the secondary winding of the transformer.

5. The power supply according to claim 4, wherein the number of turns of the first secondary winding is substantially equal to the number of turns of the second secondary winding.

6. The power supply according to claim 4, wherein
the transformer is a multilayer type transformer configured such that
the first secondary winding is wound around the bobbin, the primary winding is wound around the first secondary winding via a barrier tape, and the second secondary winding is wound around the primary winding via a barrier tape.

7. The power supply according to claim 4, wherein
the power supply includes two switching elements connected to the primary winding,
and wherein the two switching elements are driven alternately.

8. An image forming apparatus comprising:
an image forming unit configured to form an image; and
a power supply configured to supply electric power to the image forming apparatus,
wherein the power supply includes
a transformer including a core, a primary winding, a first secondary winding and a second secondary winding, and a bobbin around which the primary winding, the first secondary winding, and the second secondary winding are wound, wherein the primary winding is disposed between the first secondary winding and the second secondary winding;
a switching element connected to the primary winding,
wherein the switching element is driven to induce a voltage on the secondary winding of the transformer.

9. The image forming apparatus according to claim 8, further comprising:
a control unit configured to control an operation of the image forming unit,
wherein the power supply supplies electric power to the control unit.

10. The image forming apparatus according to claim 8, further comprising:
a driving unit configured to drive the image forming unit,
wherein the power supply supplies electric power to the driving unit.
